(19) United States
(12) Patent Application Publication
(10) Pub. No.: US 2025/0123357 A1
(43) Pub. Date: Apr. 17, 2025

(54) METHOD OF PROCESSING RADAR SIGNAL, RADAR SIGNAL PROCESSING DEVICE, AND DISPLAY DEVICE

(71) Applicants: SAMSUNG DISPLAY CO., LTD., YONGIN-SI (KR); UNIST(ULSAN NATIONAL INSTITUTE OF SCIENCE AND TECHNOLOGY), Ulsan (KR)

(72) Inventors: JAEUK CHOI, Yongin-si (KR); GANGIL BYUN, Ulsan (KR); KISEO KIM, Yongin-si (KR); JINMYEONG HEO, Ulsan (KR)

(21) Appl. No.: 18/910,204

(22) Filed: Oct. 9, 2024

(30) Foreign Application Priority Data
Oct. 12, 2023 (KR) 10-2023-0136287

(51) Int. Cl. G01S 7/35; G01S 7/41; G01S 13/34; G01S 13/42; G01S 13/58

(52) U.S. Cl. CPC G01S 7/356; G01S 7/417; G01S 13/343; G01S 13/42; G01S 13/584

(57) ABSTRACT

A method of processing a radar signal includes receiving real data of a radar signal through an I-channel, performing a range-fast Fourier transform on the radar signal that converts the real data into complex data and calculates a range, performing a Doppler-fast Fourier transform on the radar signal that calculates a Doppler velocity, and overlapping a phase difference of the radar signals that generates phase difference data and applying a Gaussian function to the phase difference data that calculates an angle.

This application claims priority under 35 U.S.C. § 119 from Korean Patent Application No. 10-2023-0136287, filed on Oct. 12, 2023 in the Korean Intellectual Property Office (KIPO), the contents of which are herein incorporated by reference in their entirety.

### TECHNICAL FIELD

Embodiments of the present inventive concept are directed to a method of processing a radar signal, a radar signal processing device, and a display device, more particularly to a method of processing a radar signal, a radar signal processing device, and a display device that acquires an object information (range, Doppler velocity, angle) using a radar signal.

### DISCUSSION OF THE RELATED ART

In general, a radar signal processing device includes a radar sensor, a processor, and a memory. The radar sensor transmits a radar signal toward an object using a transmitting antenna and receives a radar signal reflected from the object using a receiving antenna. The processor analyzes radar data, which is data of the received radar signal, to acquire an object information (range, Doppler velocity, angle). The memory stores a resolution increasing model, and the processor increases a resolution of the radar data using the resolution increase model.

However, as a number of the transmitting antennas and a number of the receiving antennas increases, an angle resolution increases but a size of the radar sensor increases. Therefore, a processor that increases the angle resolution relative to a number of antennas.

### SUMMARY

Embodiments of the present inventive concept provide a method of processing a radar signal for increasing an angle resolution relative to a number of antennas.

Embodiments of the present inventive concept provide a radar signal processing device that performs the method of processing the radar signal.

Embodiments of the present inventive concept provide a display device that includes the radar signal processing device.

In an embodiment according to the present inventive concept, a method of processing a radar signal includes receiving real data of a radar signal through an I-channel, performing a range-fast Fourier transform on the radar signal that converts the real data into complex data and calculates a range, performing a Doppler-fast Fourier transform on the radar signal that calculates a Doppler velocity, and overlapping a phase difference of the radar signals that generates phase difference data and applying a Gaussian function to the phase difference data that calculates an angle.

In an embodiment, wherein the radar signal is a FMCW (Frequency-Modulated Continuous Wave) radar signal.

In an embodiment, the method further includes generating a time-range map based on the range, generating a time-Doppler map based on the Doppler velocity, and generating a time-angle map based on the angle.

In an embodiment, the time-range map, the time-Doppler map, and the time-angle map are two-dimensional maps.

In an embodiment, the method further includes training a resolution increasing model using the time-range map, the time-Doppler map, and the time-angle map.

In an embodiment, the radar signal includes a chirp signal, and the angle is calculated for each period of the chirp signal.

In an embodiment, the Gaussian function applies a weight to the phase difference of the radar signals.

In an embodiment, the Gaussian function has a maximum weight value at an average value of the Gaussian function.

In an embodiment, the average value of the Gaussian function is determined based on a signal strength of the phase difference data.

In an embodiment according to the present inventive concept, a radar signal processing device includes a radar sensor that transmits a radar signal toward an object and receives real data of the radar signal reflected from the object through an I-channel and a processor that performs a range-fast Fourier transform on the radar signal that converts the real data into complex data and calculates a range, performs a Doppler-fast Fourier transform on the radar signal that calculates a Doppler velocity, overlaps a phase difference of the radar signals that generates phase difference data, and applies a Gaussian function to the phase difference data that calculate an angle.

In an embodiment, the radar signal is a FMCW (Frequency-Modulated Continuous Wave) radar signal.

In an embodiment, the processor generates a time-range map based on the range, generates a time-Doppler map based on the Doppler velocity and generates a time-angle map based on the angle.

In an embodiment, the time-range map, the time-Doppler map, and the time-angle map are two-dimensional maps.

In an embodiment, the radar signal processing device further includes a memory that stores a resolution increasing model. The resolution increasing model is trained using the time-range map, the time-Doppler map, and the time-angle map.

In an embodiment, the radar signal includes a chirp signal, and the angle is calculated for each period of the chirp signal.

In an embodiment, the Gaussian function applies a weight to the phase difference of the radar signals.

In an embodiment, the Gaussian function has a maximum weight value at an average value of the Gaussian function.

In an embodiment, the average value of the Gaussian function is determined based on a signal strength of the phase difference data.

In an embodiment according to the present inventive concept, a display device includes a display panel that includes pixels, a data driver that provides a data voltage to the display panel, a driving controller that controls the data driver, and a radar signal processing device that provides radar data to the driving controller. The radar signal processing device includes a radar sensor that transmits a radar signal toward an object and receives real data of the radar signal reflected from the object through an I-channel and a processor that performs a range-fast Fourier transform on the radar signal that converts the real data into complex data and calculates a range, performs a Doppler-fast Fourier transform on the radar signal that calculated a Doppler velocity, overlaps a phase difference of the radar signals that generates phase difference data, and applies a Gaussian function to the phase difference data that calculates an angle.

In an embodiment, the radar signal is a FMCW (Frequency-Modulated Continuous Wave) radar signal.

, In a radar signal processing method, a radar signal processing device, and a display device according to an embodiment, real data of a radar signal are received through the I-channel, a range-fast Fourier transform is performed on the radar signal that converts the real data into complex data and calculates a range, a Doppler-fast Fourier transform is performed on the radar signal that calculates a Doppler velocity, the phase difference of the radar signals is overlapped that generates phase the difference data, and a Gaussian function is applied to the phase difference data that calculates the angle. Accordingly, an angle resolution is increased relative to a number of antennas.

### BRIEF DESCRIPTION OF THE DRAWINGS

FIG. 1 i illustrates an object and a radar signal processing device that senses the object according to embodiments of the present inventive concept.

FIG. 2 is a block diagram of a radar signal processing device of FIG. 1.

FIG. 3 is a flowchart of a radar signal processing method performed by a radar signal processing device of FIG. 2.

FIG. 4 illustrates a radar cube.

FIG. 5 illustrates a radar cube of FIG. 4 on which a radar signal processing method of FIG. 3 is performed;

FIG. 6 illustrates a range-fast Fourier transform of FIG. 5.

FIG. 7 illustrates a Doppler-fast Fourier transform of FIG. 5.,

FIG. 8 i illustrates a conventional angle-fast Fourier transform.

FIG. 9 illustrates a phase difference of radar signals to which a Gaussian function of FIG. 3 is applied.

FIG. 10 is a block diagram of a display device that includes a radar signal processing device according to embodiments of the present inventive concept.

FIG. 11 illustrates an electronic device.

### DETAILED DESCRIPTION

Hereinafter, embodiments of the present disclosure will be described in more detail with reference to the accompanying drawings.

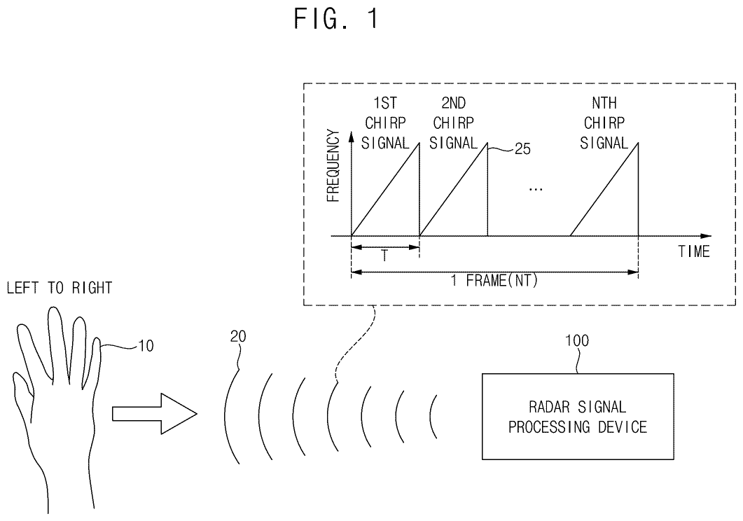

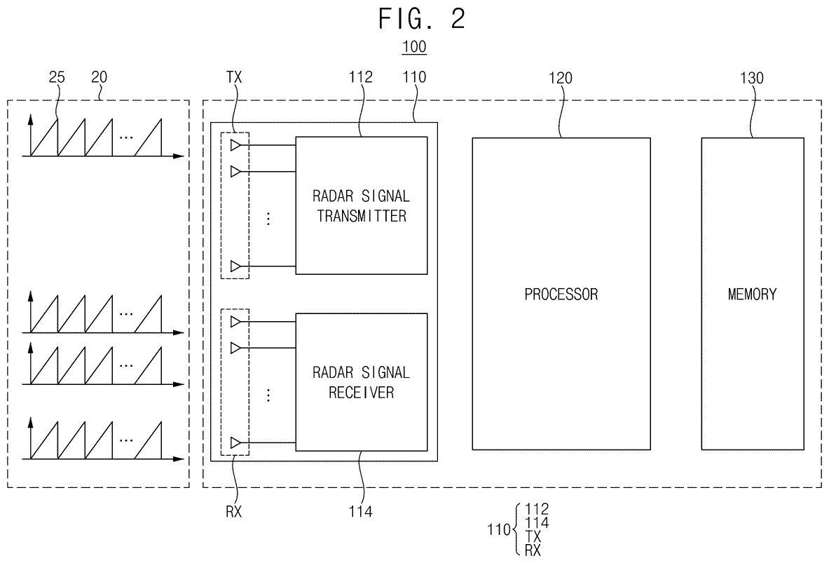

FIG. 1 illustrates an object 10 and a radar signal processing device 100 that senses the object 10 according to embodiments of the present inventive concept. FIG. 2 is a block diagram of the radar signal processing device 100 of FIG. 1.

Referring to FIGS. 1 and 2, a radar signal processing device 100 according to embodiments of the present inventive concept transmits a radar signal 20 toward an object 10 and receives a radar signal 20 reflected from the object 10. For example, the radar signal 20 is a FMCW (Frequency-Modulated Continuous Wave) radar signal. The radar signal 20 includes a plurality of chirp signals 25, and the frequency of the chirp signal 25 gradually increases over a time. For example, a period of the chirp signal 25 may be T, and a number of chirp signals 25 may be N during one frame. Therefore, one frame time may be NT. The object 10 is sensed for a plurality of frames.

The radar signal processing device 100 calculates a distance between the radar signal processing device 100 and the object 10, a relative velocity between the radar signal processing device 100 and the object 10, and an angle of the object 10 based on radar data of the radar signal 20. The distance may also be referred to as a range, and the relative velocity may also be referred to as a Doppler velocity. A resolution increasing model can be trained based on the range, the Doppler velocity, and the angle.

For example, as shown in FIG. 1, the object 10 is a human hand, and the human hand moves from left to right. The radar signal processing device 100 transmits the radar signal 20 toward the human hand and receives a radar signal 20 reflected from the human hand. The radar signal processing device 100 calculates a range, a Doppler velocity, and an angle of the human hand based on the radar signal 20.

The radar signal processing device 100 includes a radar sensor 110, a processor 120, and a memory 130.

The radar sensor 110 includes a radar signal transmitter 112, a radar signal receiver 114, a transmitting antenna TX, and a receiving antenna RX. The radar signal transmitter 112 transmits the radar signal 20 toward the object 10 using the transmission antenna TX. The radar signal receiver 114 receives the radar signal 20 reflected from the object 10 using the receiving antenna RX.

In general, a receiving antenna includes a channel that may be an I-channel or a Q-channel. The I-channel receives real data of the radar signal 20, and the Q-channel receives imaginary data of the radar signal 20.

In an embodiment, the receiving antenna RX includes only an I-channel. Therefore, the receiving antenna RX only receives the real data of the radar signal 20.

The processor 120 controls the radar sensor 110 and processes the radar data received from the radar sensor 110. The processor 120 calculates the range, the Doppler velocity, and the angle based on the radar data.

The memory 130 stores a resolution increasing model. The resolution increasing model is a deep learning model that increases a resolution of the radar data.

Deep learning refers to a technology in which electronic devices learn by combining and analyzing data to form rules on their own. In an embodiment, a deep learning algorithm is a neural network that includes a convolutional layer. For example, a structure of the neural network is one of a convolutional neural network (CNN), a very deep super resolution network (VDSR), an enhanced deep super-resolution network (EDSR), a residual dense network (RDN), or a generative adversarial network (GAN), etc. Various network structures can be modified and changed to fit the radar data and used.

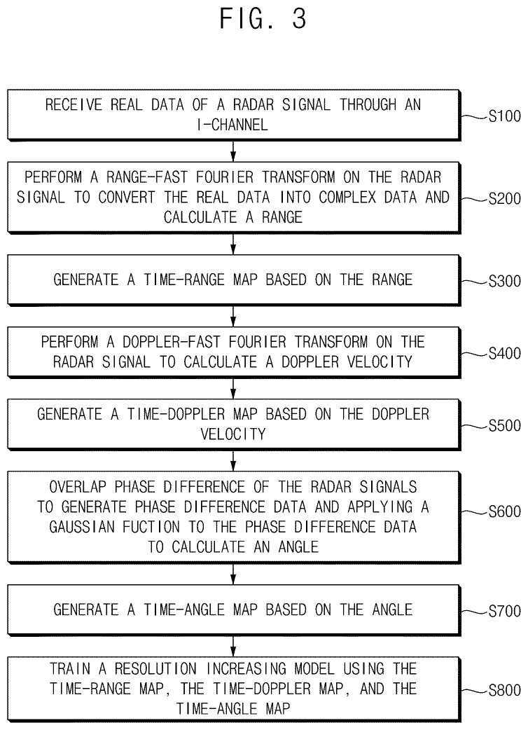

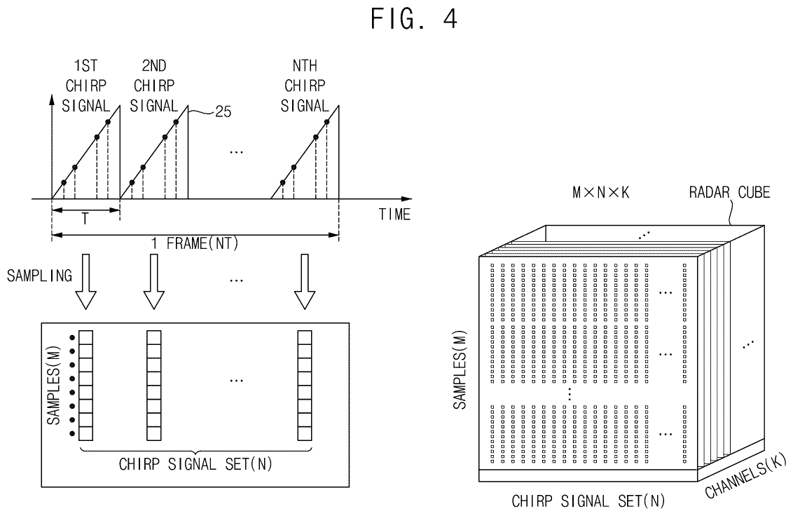

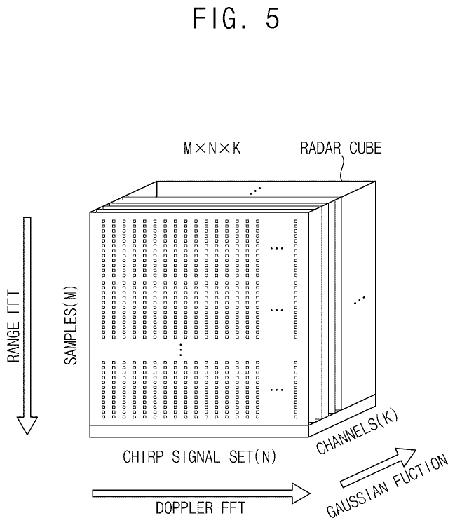

FIG. 3 is a flowchart of a radar signal processing method performed by a radar signal processing device 100 of FIG. 2. FIG. 4 illustrates a radar cube. FIG. 5 illustrates a radar cube of FIG. 4 on which a radar signal processing method of FIG. 3 is performed.

Referring to FIGS. 3 to 5, in an embodiment, a radar signal processing method includes receiving real data of a radar signal through an I-channel S100, performing a range-fast Fourier transform on the radar signal that converts the real data into complex data and calculates a range S200, performing a Doppler-fast Fourier transform on the radar signal that calculates a Doppler velocity S400, and overlapping a phase difference of the radar signals to generate phase difference data and applying a Gaussian function to the phase difference data to calculate an angle S600. A radar signal processing method according to an embodiment further includes generating a time-range map based on the range S300, generating a time-Doppler map based on the Doppler velocity S500, and generating a time-angle map based on the angle S700. A radar signal processing method according to an embodiment further includes training a resolution increasing model using the time-range map, the time-Doppler map, and the time-angle map S800.

Each of the chirp signals 25 is sampled at every sampling period Ts. Since a period of the chirp signal 25 is T, when each of the chirp signals 25 is sampled at every sampling period Ts, a number of samples during the period of the chirp signal 25 is M. In addition, since the period of the chirp signal 25 is T, a number of chirp signals 25 during one frame may be N. For example, a chirp signal set includes N chirp signals. A number of channels is K.

A radar cube of radar samples is generated for each frame. The radar cube includes a sample axis, a chirp signal set axis, and a channel axis.

The processor 120 performs a range-Fast Fourier Transformation (FFT) based on the sample axis of the radar cube, performs a Doppler-fast Fourier transformation based on the chirp signal set axis of the radar cube, overlaps the phase difference of the radar signals 20 to generate the phase difference data, and applies the Gaussian function to the phase difference data.

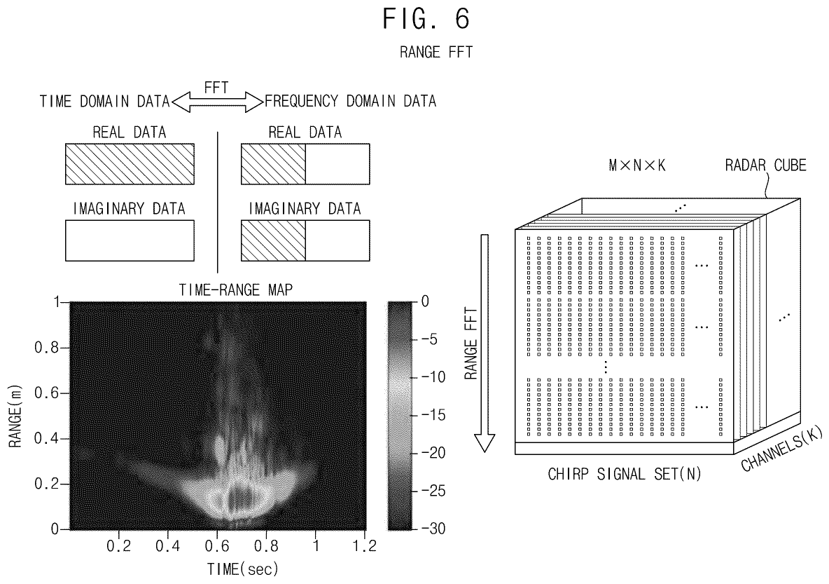

FIG. 6 illustrates a range-fast Fourier transform of FIG. 5.

Referring to FIG. 6, in an embodiment, a range-fast Fourier transform is performed based on the sample axis of the radar cube, and time domain data is changed into frequency domain data by the range-fast Fourier transform. The range-fast Fourier transform calculates the distance (i.e., the range) between the radar signal processing device 100 and the object 10. The range is calculated based on a frequency difference between the transmitted radar signal 20 and the received radar signal 20. A time-range map is created based on the range. When the range-fast Fourier transform is performed on the real data, the real data is converted into complex data. The complex data includes not only the real data but also imaginary data. Therefore, the complex data includes phase information.

FIG. 6 shows a time-range map of the motion of a human hand in FIG. 1. As shown in FIG. 6, a minimum value of a signal strength of the time-range map is-30, and a maximum value of the signal strength of the time-range map is 0. The time-range map is analyzed based on a point where the signal intensity is high over time. The signal strength of the time-range map has a significant value between 0.4 second and 0.9 second. The range is 0.2 meter at 0.4 second. The range is 0.1 meter at 0.7 second. The range is 0.2 meter at 1 second. For example, the range shortens for 0.4 second to 0.7 second and then lengthens for 0.7 second to 0.9 second.

For example, even if only the real data of the radar signal 20 is received through the I-channel without the Q-channel, the real data can be converted into complex data that includes phase information by the range-fast Fourier transform. Therefore, the number of the channels can be reduced.

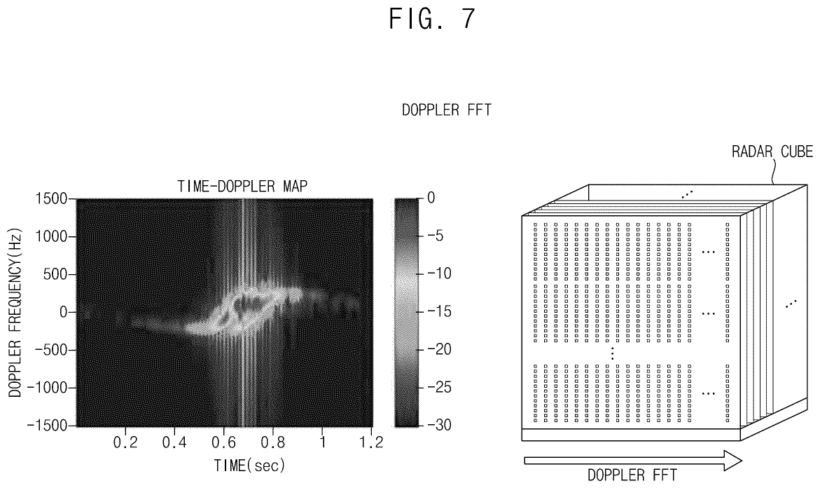

FIG. 7 illustrates a Doppler-fast Fourier transform of FIG. 5.

Referring to FIG. 7, in an embodiment, a Doppler-fast Fourier transform is performed based on the chirp signal set axis of the radar cube. A Doppler-fast Fourier transform calculates a relative velocity (i.e., the Doppler velocity) between the radar signal processing device 100 and the object 10. A Doppler frequency is calculated based on a phase difference of the radar signal 20 received through a single channel. For example, one of the I-channels receives the radar signal 20, and the Doppler frequency is calculated based on the phase difference of the radar signal 20. For example, the I-channels include a first I-channel, and the first I-channel receives the radar signal 20. The phase difference of the radar signal 20 received by the first I-channel is calculated. A time-Doppler frequency map is generated based on the Doppler frequency. The Doppler velocity is calculated based on the Doppler frequency, and a time-Doppler velocity map is generated based on the Doppler velocity. The time-Doppler frequency map or the time-Doppler velocity map may be referred to as a time-Doppler map.

FIG. 7 shows a time-Doppler map of the motion of a human hand of FIG. 1. As shown in FIG. 7, a minimum value of a signal intensity of the time-Doppler map is-30, and a maximum value of the signal intensity of the time-Doppler map is 0. The time-Doppler map is analyzed based on a point where the signal intensity is high over the time. The signal intensity of the time-Doppler map has a significant value between 0.4 second and 1 second. The Doppler frequency has a negative value at 0.4 second. The Doppler frequency is 0 Hz at 0.7 second. The Doppler frequency has a positive value at 1 second.

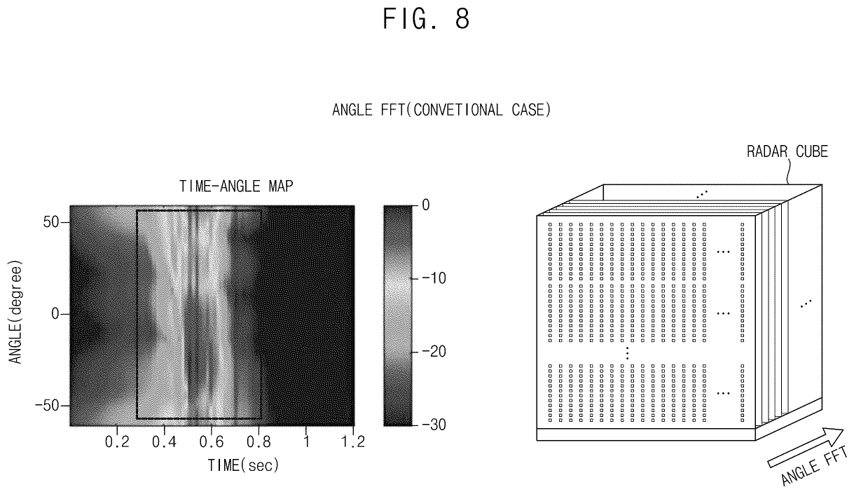

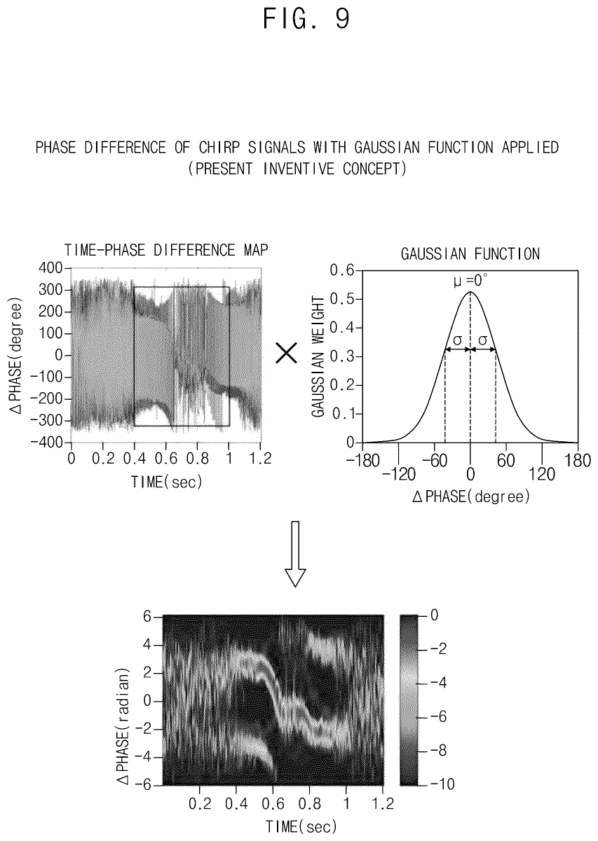

FIG. 8 illustrates a conventional angle-fast Fourier transform. FIG. 9 illustrates the phase difference of radar signals 20 to which a Gaussian function of FIG. 3 is applied.

Referring to FIGS. 8 and 9, in an embodiment, the angle is calculated based on the phase difference of radar signals 20 received through different channels. For example, any two of the I-channels receive radar signals 20, and the angle can be calculated based on a phase difference of the radar signals 20 between the two I-channels. For example, the channels include a first I-channel, a second I-channel, and a third I-channel, and the first I-channel receives a radar signal 20, the second I-channel receives a radar signal 20, and the third I-channel receives a radar signal 20. For example, a phase difference between the radar signal 20 received by the first I-channel and the radar signal 20 received by the second I-channel can be calculated, a phase difference between the radar signal 20 received by the second I-channel and the radar signal 20 received by the third I-channel can be calculated, and a phase difference between the radar signal 20 received by the third I-channel and the radar signal 20 received by the first I-channel can be calculated

In a conventional case, a channel-fast Fourier transform is performed based on the channel axis of the radar cube. The channel-fast Fourier transform calculates an angle of the object 10. The channel-fast Fourier transform is performed for each frame. Therefore, the angle can be calculated for each frame.

The processor 120 overlaps the phase differences of the radar signals 20 to generate the phase difference data. Since the radar signal processing device 100 does not perform the channel-fast Fourier transform to generate the phase difference data, the phase difference data is the time domain data. The phase difference of the radar signals 20 has a form of a wavelength. When wavelengths with a same phase overlap, constructive interference occurs and an amplitude of overlapped wavelengths increases. When wavelengths with opposite phases overlap, destructive interference occurs and an amplitude of overlapped wavelengths decreases. For example, when the phase differences of the radar signals 20 overlap, constructive interference or destructive interference can occur. Therefore, the phase difference of the radar signals 20 is further emphasized.

The processor 120 applies a Gaussian function to the phase difference data to calculate the angle and generate a time-angle map based on the angle. A Gaussian function applies a Gaussian weight to the phase difference of the radar signal 20, and the Gaussian function has a maximum weight value at an average value u of the Gaussian function. The average value u of the Gaussian function is determined based on a signal strength of the phase difference data. The average value u of the Gaussian function is a phase difference of the radar signals 20, which corresponds to a maximum value of the signal intensity of the phase difference data. Therefore, the phase difference of the radar signals 20 is further emphasized.

In addition, the radar signal processing device 100 generates phase difference data by overlapping the phase differences of the radar signals 20 without performing a channel-fast Fourier transform. Since the radar signal 20 comprises chirp signals 25 that have a period T, the angle can be calculated for each period of the chirp signal 25. Therefore, since the period T of the chirp signal 25 is shorter than one frame period NT, an angle resolution can be increased.

For example, the radar signal processing device 100 does not perform the channel-fast Fourier transform but overlaps the phase differences of the radar signals 20 to generate the phase difference data, and applies a Gaussian function to the phase difference to calculate the angle. Accordingly, the angle resolution can be increased.

As shown in FIG. 8, in a conventional case, the angle can be calculated for each frame. Therefore, a resolution of the time-angle map of FIG. 8 is low. However, as shown in FIG. 9, in an embodiment of the present inventive concept, the angle is calculated for each period of the chirp signal 25. Therefore, a resolution of the time-angle map of FIG. 9 may be high. In FIGS. 8 and 9, a minimum value of a signal intensity of a time-angle map is-30, and a maximum value of the signal intensity of the time-angle map is 0. The time-angle map is analyzed based on a point where the signal intensity is high over the time. However, as shown in FIG. 8, the signal intensity of the time-angle map increases from 0.4 second to 0.8 second, but the time-angle map might not have a specific angle at a specific time. However, as shown in FIG. 9, the signal intensity of the time-angle map can be analyzed to have a significant value from 0.4 second to 1 second, and the angle is analyzed to gradually decrease from 0.4 second to 1 second. For example, the angle resolution is greater in FIG. 9 than in FIG. 8.

In an embodiment, a resolution increasing model can be trained using the time-range map, the time-Doppler map, and the time-angle map, and the time-range map, the time-Doppler map, and the time-angle map are two-dimensional maps rather than a three-dimensional map.

In a conventional case, a range-Doppler map and an angle-Doppler map are used to train the resolution increasing model. However, to train the resolution increasing model, information about time is needed. Therefore, the range-Doppler map is accumulated over time, and the range-Doppler-time map, which is a three-dimensional map, is formed. The angle-Doppler map is accumulated over time, and the angle-Doppler-time map, which is a three-dimensional map, is formed. However, as a dimension of a map used to train the resolution increasing model increases, an amount of training calculations increases, and as the amount of training calculations increases, a training time increases. Therefore, when the range-Doppler-time map and the angle-Doppler-time map are used to train the resolution increasing model, the training time can be long.

To reduce the training time, two-dimensional maps such as the time-range map, the time-Doppler map, and the time-angle map are used. Since a two-dimensional map has a lower dimension than a three-dimensional map, the training time can be reduced.

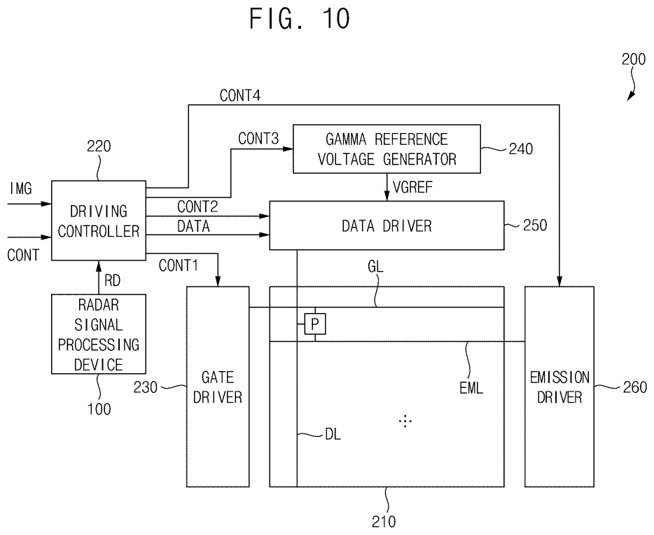

FIG. 10 is a block diagram of a display device 200 that includes the radar signal processing device 100 according to embodiments of the present inventive concept.

Referring to FIG. 10, in an embodiment, the display device 200 includes a display panel 210 and a display panel driver. The display panel driver includes a driving controller 220, a gate driver 230, a gamma reference voltage generator 240, a data driver 250, and an emission driver 260. The display device further includes a radar signal processing device 100.

For example, the driving controller 220 and the data driver 250 are integrally formed. For example, the driving controller 220, the gamma reference voltage generator 240, and the data driver 250 are integrally formed. For example, the driving controller 220, the gate driver 230, the gamma reference voltage generator 240, and the data driver 250 are integrally formed. For example, the driving controller 220, the gate driver 230, the gamma reference voltage generator 240, the data driver 250, and the emission driver 260 are integrally formed. A driving module in which at least the driving controller 220 and the data driver 250 are integrally formed may be referred to as a timing controller embedded data driver (TED).

The display panel 210 includes a display region that can display an image and a peripheral region disposed adjacent to the display region.

For example, in a present embodiment, the display panel 210 is an organic light emitting diode display panel that includes an organic light emitting diode. For example, the display panel 210 is a quantum-dot organic light emitting diode display panel that includes an organic light emitting diode and a quantum-dot color filter. For example, the display panel 210 is a quantum-dot nano light emitting diode display panel that includes a nano light emitting diode and a quantum-dot color filter.

The display panel 210 includes gate lines GL, data lines DL, emission lines EML and pixel circuits P electrically connected to the gate lines GL, the data lines DL and the emission lines EML, respectively. The gate lines GL extend in a first direction, the data lines DL extend in a second direction that crosses the first direction and the emission lines EML extend in the first direction.

The driving controller 220 receives input image data IMG and an input control signal CONT from an external device. For example, the input image data IMG includes red image data, green image data and blue image data. The input image data IMG may include white image data. For example, the input image data IMG includes magenta image data, yellow image data, and cyan image data. The input control signal CONT includes a master clock signal and a data enable signal. The input control signal CONT further includes a vertical synchronization signal and a horizontal synchronization signal.

The driving controller 220 generates a first control signal CONT1, a second control signal CONT2, a third control signal CONT3, a fourth control signal CONT4 and a data signal DATA based on the input image data IMG and the input control signal CONT.

The driving controller 220 generates the first control signal CONT1 to control operation of the gate driver 230 based on the input control signal CONT, and outputs the first control signal CONT1 to the gate driver 230. The first control signal CONT1 includes a vertical start signal and a gate clock signal.

The driving controller 220 generates the second control signal CONT2 to control operation of the data driver 250 based on the input control signal CONT, and outputs the second control signal CONT2 to the data driver 250. The second control signal CONT2 includes a horizontal start signal and a load signal.

The driving controller 220 generates the data signal DATA based on the input image data IMG. The driving controller 220 outputs the data signal DATA to the data driver 250.

The driving controller 220 generates the third control signal CONT3 to control operation of the gamma reference voltage generator 240 based on the input control signal CONT, and outputs the third control signal CONT3 to the gamma reference voltage generator 240.

The driving controller 220 generates the fourth control signal CONT4 to control operation of the emission driver 260 based on the input control signal CONT, and outputs the fourth control signal CONT4 to the emission driver 260.

The gate driver 230 generates gate signals that drive the gate lines GL in response to the first control signal CONT1 received from the driving controller 220. The gate driver 230 outputs the gate signals to the gate lines GL.

In an embodiment, the gate driver 230 is integrated onto the peripheral region of the display panel 210.

The gamma reference voltage generator 240 generates a gamma reference voltage VGREF in response to the third control signal CONT3 received from the driving controller 220. The gamma reference voltage generator 240 provides the gamma reference voltage VGREF to the data driver 250. The gamma reference voltage VGREF has a value that respectively corresponds to each data signal DATA.

For example, the gamma reference voltage generator 240 may be integrated into the driving controller 220 or may be integrated into the data driver 250.

The data driver 250 receives the second control signal CONT2 and the data signal DATA from the driving controller 220, and receives the gamma reference voltage VGREF from the gamma reference voltage generator 240. The data driver 250 converts the data signal DATA into an analog data voltage using the gamma reference voltage VGREF. The data driver 250 outputs the data voltage to the data line DL.

The emission driver 260 generates emission signals that drive the emission lines EML in response to the fourth control signal CONT4 received from the driving controller 220. The emission driver 260 outputs the emission signals to the emission lines EML.

In an embodiment, the emission driver 260 is integrated into the peripheral region of the display panel 210. In an embodiment, the emission driver 260 is mounted on the peripheral region of the display panel 210.

For convenience of illustration, FIG. 10 shows that the gate driver 230 is disposed on a first side of the display panel 210 and the emission driver 260 is disposed on a second side of the display panel 210. However, embodiments of the present inventive concept are not necessarily limited thereto. For example, in some embodiments, both the gate driver 230 and the emission driver 260 are disposed on the first side of the display panel 210. For example, in some embodiments, the gate driver 230 and the emission driver 260 are disposed on both sides of the display panel 210. For example, in some embodiments, the gate driver 230 and the emission driver 260 are integrally formed.

The driving controller 220 further receives radar data RD from the radar signal processing device 100.

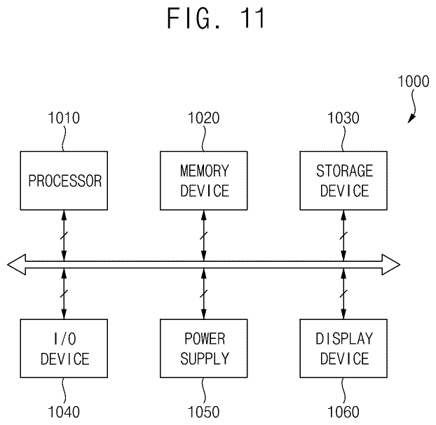

FIG. 11 is a block diagram of an electronic device 1000.

Referring to FIG. 11, in an embodiment, the electronic device 1000 includes a processor 1010, a memory device 1020, a storage device 1030, an input/output (I/O) device 1040, a power supply 1050, and a display device 1060. In addition, the electronic device 1000 further includes a plurality of ports that communicate with a video card, a sound card, a memory card, a universal serial bus (USB) device, other electronic devices, etc.

In an embodiment, the electronic device 1000 is implemented as a smart device. However, embodiments of the electronic device 1000 are not necessarily limited thereto. For example, the electronic device 1000 is implemented as one of a cellular phone, a video phone, a smart pad, a smart watch, a tablet PC, a car navigation system, a computer monitor, a laptop, or a head mounted display (HMD) device, etc.

The processor 1010 performs various computing functions. The processor 1010 is one of a micro processor, a central processing unit (CPU), or an application processor (AP), etc. The processor 1010 is coupled to other components via one of an address bus, a control bus, or a data bus. Further, the processor 1010 may be coupled to an extended bus such as a peripheral component interconnection (PCI) bus.

The memory device 1020 stores data for operating the electronic device 1000. For example, the memory device 1020 includes at least one non-volatile memory device such as one or more of an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, or a ferroelectric random access memory (FRAM) device, etc., and/or at least one volatile memory device such as one or more of a dynamic random access memory (DRAM) device, a static random access memory (SRAM) device, or a mobile DRAM device, tec.

The storage device 1030 includes one or more of a solid state drive (SSD) device, a hard disk drive (HDD) device, or a CD-ROM device, etc.

The I/O device 1040 includes an input device such as a keyboard, a keypad, a mouse device, a touch-pad, a touch-screen, etc., and an output device such as a printer, a speaker, etc. In some embodiments, the I/O device 1040 includes the display device 1060.

The power supply 1050 provides power for operating the electronic device 1000.

The display device 1060 is connected to other components through buses or other communication links.

Embodiments of the inventive concepts can be incorporated into any display device and any electronic device that includes a touch panel. For example, embodiments of the inventive concepts can be incorporated into a mobile phone, a smart phone, a tablet computer, a digital television (TV), a 3D TV, a personal computer (PC), a home appliance, a laptop computer, a personal digital assistant (PDA), a portable multimedia player (PMP), a digital camera, a music player, a portable game console, a navigation device, etc.

The foregoing is illustrative of embodiments of the inventive concept and is not to be construed as limiting thereof. Although embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. Therefore, it is to be understood that the foregoing is illustrative of embodiments of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A method of processing a radar signal, the method comprising:
receiving real data of a radar signal through an I-channel;
performing a range-fast Fourier transform on the radar signal that converts the real data into complex data and calculates a range;
performing a Doppler-fast Fourier transform on the radar signal that calculates a Doppler velocity; and
overlapping a phase difference of the radar signals that generates phase difference data and applying a Gaussian function to the phase difference data that calculates an angle.

2. The method of claim 1, wherein the radar signal is a FMCW (Frequency-Modulated Continuous Wave) radar signal.

3. The method of claim 1, further comprising:
generating a time-range map based on the range;
generating a time-Doppler map based on the Doppler velocity; and
generating a time-angle map based on the angle.

4. The method of claim 3, wherein the time-range map, the time-Doppler map, and the time-angle map are two-dimensional maps.

5. The method of claim 3, further comprising:
training a resolution increasing model using the time-range map, the time-Doppler map, and the time-angle map.

6. The method of claim 1, wherein the radar signal includes a chirp signal, and the angle is calculated for each period of the chirp signal.

7. The method of claim 1, wherein the Gaussian function applies a weight to the phase difference of the radar signals.

8. The method of claim 7, wherein the Gaussian function has a maximum weight value at an average value of the Gaussian function.

9. The method of claim 8, wherein the average value of the Gaussian function is determined based on a signal strength of the phase difference data.

10. A radar signal processing device, comprising:
a radar sensor that transmits a radar signal toward an object and receives real data of the radar signal reflected from the object through an I-channel; and
a processor that performs a range-fast Fourier transform on the radar signal and that converts the real data into complex data and calculates a range, performs a Doppler-fast Fourier transform on the radar signal that calculates a Doppler velocity, overlaps a phase difference of the radar signals that generates phase difference data, and applies a Gaussian function to the phase difference data that calculates an angle.

11. The radar signal processing device of claim 10, wherein the radar signal is a FMCW (Frequency-Modulated Continuous Wave) radar signal.

12. The radar signal processing device of claim 10, wherein the processor generates a time-range map based on the range, generates a time-Doppler map based on the Doppler velocity, and generates a time-angle map based on the angle.

13. The radar signal processing device of claim 12, wherein the time-range map, the time-Doppler map, and the time-angle map are two-dimensional maps.

14. The radar signal processing device of claim 12, further comprising:
a memory that stores a resolution increasing model,
wherein the resolution increasing model is trained using the time-range map, the time-Doppler map, and the time-angle map.

15. The radar signal processing device of claim 10, wherein
the radar signal includes a chirp signal, and
the angle is calculated for each period of the chirp signal.

16. The radar signal processing device of claim 10, wherein the Gaussian function applies weight to the phase difference of the radar signals.

17. The radar signal processing device of claim 16, wherein the Gaussian function has a maximum weight value at an average value of the Gaussian function.

18. The radar signal processing device of claim 17, wherein the average value of the Gaussian function is determined based on a signal strength of the phase difference data.

19. A display device, comprising:
a display panel that includes pixels;
a data driver that provides a data voltage to the display panel;
a driving controller that controls the data driver; and
a radar signal processing device that provides radar data to the driving controller,
wherein the radar signal processing device includes:
a radar sensor that transmits a radar signal toward an object and receives real data of the radar signal reflected from the object through an I-channel; and
a processor that performs a range-fast Fourier transform on the radar signal that converts the real data into complex data and calculates a range, performs a Doppler-fast Fourier transform on the radar signal that calculates a Doppler velocity, overlaps a phase difference of the radar signals that generates phase difference data, and applies a Gaussian function to the phase difference data that calculates an angle.

20. The display device of claim 19, wherein the radar signal is a FMCW (Frequency-Modulated Continuous Wave) radar signal.
